(19) United States
(12) Patent Application Publication
(10) Pub. No.: US 2024/0305846 A1
(43) Pub. Date: Sep. 12, 2024

(54) Automated Content Availability Management

(71) Applicant: DISH Network L.L.C., Englewood, CO (US)

(72) Inventors: Darlene Frederickson, Arvada, CO (US); Chris Kwiatkowski, Parker, CO (US)

(73) Assignee: DISH Network L.L.C., Englewood, CO (US)

(21) Appl. No.: 18/119,465

(22) Filed: Mar. 9, 2023

(51) Int. Cl. H04N 21/266; H04N 21/238

(52) U.S. Cl. CPC H04N 21/266; H04N 21/238

(57) ABSTRACT

Devices, systems and processes are disclosed for automated content availability management. A process may include executing, by a first processor in a programming server, computer instructions which instantiate a program engine that instructs the programming server to perform first operations including receiving a program status change message from a content source, wherein the program status change message identifies a program, of a plurality of programs provided by the content source to one or more user devices, subject to a change in program availability, extracting from the program status change message an immediacy status for the change in program availability, determining whether the immediacy status is imminent or not imminent, generating a program instruction when the immediacy status is imminent, wherein the program instruction identifies the program subject to the change in program availability, and communicating the program instruction to an access designation server.

### TECHNICAL FIELD

The technology described herein generally relates to devices, systems, and processes for managing the availability of audio/video channels to various users via content distribution systems including satellite, cable, and Internet based distribution systems.

### BACKGROUND

An audio-video content and/or other form of content distribution system commonly includes hundreds of channels provided by numerous content sources. The content distribution system often engages in vigorous negotiations with content sources regarding terms under which one or more of such channels may be distributed to users of the content distribution system. Occasionally, such discussions are delayed, with a resolution not being reached, before terms of a previously engaged contract expire or otherwise become non-effective—thereby preventing the content distribution system from providing the one or more channels to the users at a given time and/or under one more previously agreed upon terms and conditions. Accordingly, the one or more so impacted channels are often “taken down” from the content distribution system. When a “takedown” of one or more channels occurs, the takedown typically requires immediate actions by programming functions within a content distribution system, access control functions within the content distribution system, and external web/Cloud based functions, such as those providing web servers, content distribution network nodes, or the like.

Currently, channel take downs occur based upon a series of manual inputs by one or more of the above functions of the content distribution system. Such manual inputting results in delays with take down compliance requirements, may lead to errors, and can be complicated when take downs apply for some user, but not all users, of a given one or more channels. Accordingly, systems and methods are needed for automating the take down of channels on a substantially simultaneous basis, as determined in view of when a prior content agreement expires or is otherwise modified such that a takedown is to occur of one or more channels. Further, system and methods are needed which automate the bringing back of one or more channels previously taken down, newly added to the content distribution system, or the like.

### SUMMARY

Various implementations are described of devices, systems, and processes for managing the availability of audio/video channels to users via content distribution systems including satellite, cable, and Internet based distribution systems.

In accordance with at least one implementation of the present disclosure, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

For at least one implementation, a process may include executing, by a first processor in a programming server, non-transient computer instructions which instantiate a program engine. The program engine may instruct the programming server to perform first operations that may include receiving a program status change message from a content source. The program status change message may identify a program, of a plurality of programs provided by the content source to one or more user devices, subject to a change in program availability. The first operations may also include extracting from the program status change message an immediacy status for the change in program availability, determining whether the immediacy status is imminent or not imminent, and generating a program instruction when the immediacy status is imminent. The program instruction may identify the program subject to the change in program availability. The first operations may also include communicating the program instruction to an access designation server.

For at least one implementation, process may include executing, by a second processor in the access designation server, non-transient computer instructions which instantiate an access engine. The access engine may instruct the access designation server to perform second operations that may include receiving the program instruction from the programming server, and determining whether the program instruction designates the change in program availability will occur or may occur. When the program instruction designates the change in program availability status will occur the second operations may include determining the program from the plurality of programs, subject to the change in program availability, determining one or more Designated Criteria (DC(s)) implicated by the change in program availability, and generating a Management Layer Instruction (MLI). The MLI may identify the one or more DC(s) implicated by the change in program availability. The second operations may also include communicating the MLI to a content control server.

For at least one implementation, the process may include executing, by a third processor in the content control server, non-transient computer instructions which instantiate a control engine. The control engine may instruct the content control server to perform third operations that may include receiving the MLI from the access designation server, identifying at least one user device, from the one or more user devices, implicated by the MLI, and instructing at least one distribution node of a distribution network of at least one of the program, the DC(s) and the at least one user device implicated by the MLI.

For at least one implementation and upon being instructed of at least one of the program, the DC(s), and the at least one user device implicated by the MLI, the at least one distribution node may be reconfigured in accordance with the program status change message. The reconfiguring of the at least one distribution node may result in the program being unavailable for providing to the at least one user device implicated by the MLI. The reconfiguring of the at least one distribution node may result in the program becoming available for providing to the at least one user device implicated by the MLI.

For at least one implementation, the content source may be on a content source layer of a content availability management system (CAMS). The programming server may be on a management layer of the CAMS and coupled to the content source. The content control server may be on a distribution layer of the CAMS and coupled to the programming server.

For at least one implementation, the access designation server may be conceptually located on the management layer. The at least one distribution node may be on the distribution layer and coupled to the content control server. The at least one user device may be on a user layer of the CAMS and coupled to the programming server and to the at least one distribution node. The at least one user device may receive the program, when available, from the content source via the at least one distribution node.

For at least one implementation, the DC(s) may identify at least one characteristic of the at least one user device. The DC(s) may identify a Designated Market Area (DMA).

For at least one implementation of the present disclosure, a system may include a content source, a programming server, an access designation server, and a content control server. The programming server may include a first processor, a first communications interface coupling the programming server with the access control server and with the content source, and a first data store, coupled to the first processor, storing first non-transient computer instructions which, when executed by the first processor, instantiate a program engine. The program engine may instruct the programming server to perform first operations that may include receiving a program status change message from a content source. The program status change message may identify a program, of a plurality of programs provided by the content source to one or more user devices, subject to a change in program availability. The first operations may include extracting from the program status change message an immediacy status for the change in program availability and determining whether the immediacy status is imminent or not imminent. Other embodiments of this aspect include corresponding computer systems, apparatus, and computer programs recorded on one or more computer storage devices, each configured to perform the actions of the methods.

For at least one implementation of a system and when the immediacy status is imminent, the first operations may include generating a program instruction that identifies the program subject to the change in program availability and communicating the program instruction to an access designation server. The access designation server may include a second processor, a second communications interface coupling the access designation server with the programming server and the content control server, and a second data store, coupled to the second processor, storing second non-transient computer instructions which, when executed by the second processor, instantiates an access engine which instructs the access designation server to perform second operations. The second operations may include receiving a program instruction from the programming server and determining whether the program instruction designates the change in program availability will occur. When the program instruction designates the change in program availability status will occur, the second operations may include determining the program from the plurality of programs, subject to the change in program availability, determining one or more Designated Criteria (DC(s)) implicated by the change in program availability, generating a Management Layer Instruction (MLI), and where the MLI identifies the one or more DC(s) implicated by the change in program availability, communicating the MLI to a content control server.

For at least one implementation, the content control server may include a third processor, a third communications interface coupling the content control server with the access control server, and a distribution network. The distribution network may include at least one distribution node and a third data store, coupled to the third processor, storing third non-transient computer instructions which, when executed by the third processor, instantiate a control engine. The control engine may instruct the content control server to perform third operations that may include receiving the MLI from the access designation server, identifying at least one user device, from the one or more user devices, implicated by the MLI, and instructing the at least one distribution node of the distribution network of the program, the DC(s), and the at least one user device implicated by the MLI. The DC(s) may identify at least one characteristic of the at least one user device implicated by the MLI. The DC(s) identify a Designated Market Area (DMA).

For at least one implementation of the present disclosure, a system may include a management layer including a first server, a content source layer including a content source, a distribution layer including a content control sever and at least one distribution node, and a user layer including at least one user device. The management layer may be coupled to the content source layer and the distribution layer. The distribution layer may be coupled to the content source layer and the user layer. The first server may perform first operations that may include receiving a program status change message from a content source. The program status change message may identify a program, of a plurality of programs provided by the content source to one or more user devices, subject to a change in program availability. The operations may include extracting from the program status change message an immediacy status for the change in program availability and determining whether the immediacy status is imminent or not imminent. When the immediacy status is imminent, the operations may include generating a program instruction that identifies the program subject to the change in program availability, and determining whether the program instruction designates the change in program availability will occur or may occur. When the program instruction designates the change in program availability status will occur, the operations may include determining the program from the plurality of programs, subject to the change in program availability, determining one or more Designated Criteria (DC(s)) implicated by the change in program availability, generating a Management Layer Instruction (MLI) which identifies the one or more DC(s) implicated by the change in program availability, and communicating the MLI to a content control server. Other embodiments of this aspect include corresponding computer systems, apparatus, and computer programs recorded on one or more computer storage devices, each configured to perform the actions of the methods.

For at least one implementation, the content control server may perform content control operations that may include receiving the MLI from the first server, identifying the at least one user device, from a one or more user devices, implicated by the MLI, and instructing the at least one distribution node of the program, the DC(s), and the at least one user device implicated by the MLI.

### BRIEF DESCRIPTION OF THE DRAWINGS

The features, aspects, advantages, functions, modules, and components of the devices, systems and processes provided by the various implementations of implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic illustration of a content availability management system in accordance with at least one implementation of the present disclosure.

FIG. 2 is a schematic for a server utilized in the content availability management system of FIG. 1 and in accordance with at least one implementation of the present disclosure.

FIG. 3 is a flow chart illustrating one process for managing the availability of content and in accordance with at least one implementation of the present disclosure.

### DETAILED DESCRIPTION

Various implementations of the present disclosure describe devices, systems, and processes for managing the availability of content by a “Content Availability Management System” (CAMS).

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals”). An AIO signal may not include an audible signal or a visible signal but may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to, or from, one or more users as an AIO signal may be utilized for at least one implementation of the present disclosure. An AIOI generally includes hardware and computer instructions (herein, “AIO technologies”) which supports the input and output of other signals with a user.

“Application” herein refers to a set of computer instructions that configure one or more processors perform one or more tasks that are other than tasks commonly associated with the operation of the processor itself (e.g., a “system software,” an example being an operating system software), or the providing one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface generally includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize and capture comments spoken by a user and intended as audible signals for sharing with other users, inputting commands, or otherwise.

“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources. A usage of a Cloud resource may be private (limited to various users and/or uses), public (available for many users and/or uses), hybrid, dedicated, non-dedicated, or otherwise. It is to be appreciated that implementations of the present disclosure may use Cloud resources to provide for processing, storage and other functions related to facilitating managing the availability of content to user of content distribution systems. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazon.com Inc., AZURE provided by Microsoft Corp., and others.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Content” herein refers to data that may be presented, using a suitable presentation device, to a user in a humanly perceptible format. When presented to a human, the data becomes “information.” Non-limiting examples of content include audio and video images, textual information, graphical information, virtual reality information, augmented reality information and the like. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized. Content may be provided on an individualized, group, or other basis. The providing of content is herein referred to a being provided on a “channel” which may include an identified content stream on the Internet, a television broadcast identifier, or otherwise. Herein, a channel refers to a grouping of content. A given instance of content, a collection of content, a channel, a collection of channels, or otherwise may herein be individually and collectively referred to as a “program”.

“Content Source Layer” (CSL) herein refers to one or more computer servers, data storage devices, applications, and the like which, singularly and/or cooperatively, provide content to the Distribution Layer (DL) for further providing, thereby, to the User Layer (UL). A CSL may include one or more “Content Source Layer Elements” (CLEs) including servers, data stores, communications interfaces, user interfaces, security, power, busses, and related components. CSLEs may be physically, logically, virtually or otherwise grouped and/or coupled to provide content to the DL. One or more CSLEs may be provided on the Cloud and/or otherwise.

“Coupling” herein refers to establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), VOIP, Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” (which is also referred to herein as a “computer data”) herein refers to any representation of facts, information or concepts in a form suitable for processing, storage or the like by one or more electronic device processors, data stores, or the like. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in memory, data storage device, or otherwise, the given data packet may again have a non-transient state. For example, and not by limitation, data may take any form including as one or more applications, content, or otherwise.

“Data store” herein refers to any device or combinations of devices configured to store data on a temporary, permanent, transient, non-transient, or other basis. A data store may store data in any form, such as electrically, magnetically, physically, optically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transient data, computer instructions, or other the like may be suitably stored in a data store. As used herein, permanent storage is distinguished from temporary storage, with the latter providing a location for temporarily storing data, variables, or other instructions used for a then arising data processing operation. A non-limiting example of a temporary storage is a memory component provided with and/or embedded onto a processor or integrated circuit provided therewith for use in performing then or soon thereafter arising data calculations and operations. Accordingly, it is to be appreciated that a reference herein to “temporary storage” is not to be interpreted as being a reference to transient storage of data. Permanent storage and/or temporary storage may be used to store transient and non-transient data and content.

“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.

“Distribution Layer” (DL) herein refers to one or more computer servers, data storage devices, applications, and the like which, singularly and/or cooperatively, address one or more content availability management functions and facilitate the providing of available content to the User Layer (UL) and to one or more user devices. A DL may include one or more “Distribution Layer Elements” (DLEs) including servers, data stores, communications interfaces, user interfaces, security, power, busses, and related components. The DLEs may be physically, logically, virtually or otherwise grouped and/or coupled to facilitate the one or more content distribution functions including, but not limited to, those identified herein. One or more DLEs may be provided on the Cloud and/or otherwise.

“Management Layer” (ML) herein refers to one or more user devices, servers, data storage, communications interfaces, and related components which, singularly and/or cooperatively, address one or more content availability management functions, herein each being a “ML element” (MLE). As used herein, a “Management Layer Function” (MLF) is one or more data processing and/or communications operations performed by one or more MLEs which facilitate identification of content, source(s) of such content, content availability limitations by source or otherwise, content availability networks, and content access options for one or more users. A MLF may include a “Management Layer Instruction” (MLI), which may be provided by one MLE to another MLE, and/or to a DLE. A MLE may include one or more user devices, servers, data stores, communications interfaces, user interfaces, busses, and related components. A MLE may be physically, logically, virtually or otherwise grouped and/or coupled to facilitate the one or MLFs including, but not limited to, those identified herein. One or more MLEs may be provided on the Cloud and/or otherwise.

“Instruction” (which is also referred to herein as a “computer instruction”) herein refers to a non-transient processor executable instruction, associated data structure, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Module” herein refers to and, when claimed, recites definite structure for an electrical/electronic device that is configured to provide at least one feature and/or output signal and/or perform at least one function including the features, output signals and functions described herein. Such a module may provide the one or more functions using computer engines, processors, computer instructions and the like. When a feature, output signal and/or function is provided, in whole or in part, using a processor, one more software components may be used and a given module may include a processor configured to execute computer instructions. A person of ordinary skill in the art (a “POSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Power Supply/Power” herein refers to any known or later arising technologies which facilitate the use of electrical energy by a device. Non-limiting examples of such technologies include batteries, power converters, inductive charging components, line-power components, solar power components, and otherwise.

“Processor” herein refers to one or more known or later developed hardware processors and/or processor systems configured to execute one or more computer instructions, with respect to one or more instances of data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Real-time” herein refers to a presentation of information to a human that occurs substantially simultaneously with a resolution of an event.

“Security Component/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as a Microsoft WINDOWS based operating systems, LINUX, APPLE OS, ANDROID, and others, as an application program on a given device, as a web service, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay.

“User Device” herein refers to a device configured for use by a human being to one or more of communicate, receive, transmit, present, process, store and/or otherwise manage content. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user. A user interface may include one more Additional I/O interfaces, Audio I/O interfaces, and Visual I/O interfaces.

“User Layer” herein refers to one or more user devices configured to receive, process, store and/or otherwise manage content, including content received from one or more DLEs, by and/or under the direction and/or control of a user via a user device.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface generally includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Content Availability Management System 100

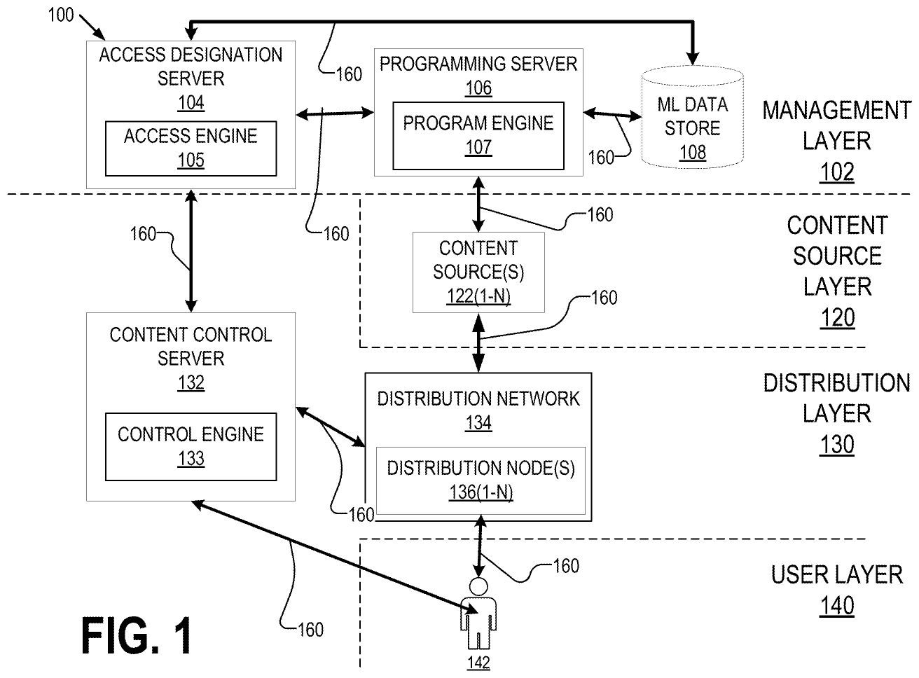

As shown in FIG. 1 and for at least one implementation of the present disclosure, a content availability management (CAMS) 100, may logically and/or physically include a Management Layer (ML) 102 that is respectively coupled to a Content Source Layer (CSL) 120 and to a Distribution layer (DL) 130. The DL 130 is coupled to a User Layer (UL) 140. The various layers may be coupled by one or more couplings 160.

For at least one implementation, the ML 102 identifies and designates, via one or more MLIs how/when/where and/or as otherwise specified, content that is available to one or more user devices 142 coupled to the UL 140 at a given time. The content may be uniquely identified, identified by one or more channel designations, or otherwise. The given time may be at a past, present, and/or future time and/or period. The period may be finite, indefinite, dependent on one or more other events or activities, or otherwise.

The DL 130 may be configured to obtain content from the CSL 120 and provide such content and/or facilitate direct and/or indirect access to such content by one or more user devices 142, in accordance with in one or more MLIs, and at any given time. For at least one implementation, the DL 130 may provide, retrieve, restrict, permit or otherwise govern the retrieval, presentation and/or other use of content, as provided by one or more content sources 122(1-N) (where “N” is an integer), by a user device 142, in accordance with MLIs provided by the management layer 102. The DL 130 may be configured to provide content on one or more channels.

An MLI may be provided and/or universal, specific, or otherwise applicable to user devices based on any given criteria which are herein a “Designated Criteria” (DC). A DC may specify a given one or more user devices; a collection of user devices (e.g., user devices having certain subscription rights being granted access to a given content, while other user device having other subscription rights are not granted access to the given content); a type of user device (e.g., set top boxes, mobile devices and the like); a characteristic of a user device (e.g., user devices executing the ANDROID operating system, APPLE OS, WINDOWs, or otherwise); a region of user devices (e.g., user devices in the Denver, Colorado DMA not having access to content provided by a local broadcasting station for a given network, while user devices in other DMAs continuing to have access to such content provided by the given network); or otherwise. For at least one implementation, a DC may correspond to “Designated Market Area” (DMA), as such are specified by the U.S. Federal Communications Commission. A DC may designate one or more DMAs or other regions.

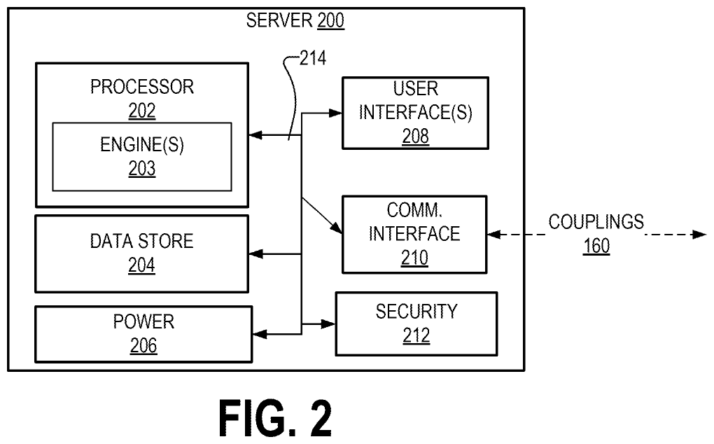

The ML 102 may include one or more servers (as described below and with reference to FIG. 2), including an access designation server 104 and a programming server 106, and one or more data stores such as a ML data store 108. For at least one implementation, the access designation server 104 receives channel availability data from the programming server 106, updates one or more content and/or channel availability data listings, and communicates designations for one or more content and/or content sources, in an MLI, to the DL 130. The channel availability data listing, and updates thereto, may be stored in the ML data store 108. The channel availability data listing may correspond to one or more entries on a program guide, a channel listing, or otherwise.

For at least one implementation, the programming server 106 communicates with one or more content sources 122 (1-N), each being associated with a CSLE, on the CSL 120 to identify which content (as may be represented for at least one implementation by one or more instances of content and/or by one or more channels) is available, at any given time, for providing by the DL 130 to one or more user devices 142 and presentation thereby.

A CSLE may be associated with one or more sources of content (and/or channels) with non-limiting examples including broadcast television networks (e.g., ABC, CBS, NBC and FOX), regional broadcasting stations (e.g., KMGH and KUSA), cable/satellite networks (e.g., HBO and ESPN), streaming channels (e.g., web based applications for ESPN, PARAMOUNT+, HBO NOW), user generated content (e.g., as provided by YOUTUBE, FACEBOOK, INSTAGRAM, TICKTOCK), and/or any other form and/or source of content and/or channels. It is to be appreciated that a given content/channel may be provided by one or more CSLEs and/or content sources 122(1-N) at any given time.

For at least one implementation, the programming server 106 may provide, to the access designation server 104, in a “programming instruction” content availability data that includes indications of instances of content and/or channels becoming (un)available at a future time, such as when contractual negotiations between a given content source and a given distribution system (e.g., DISH NETWORK and SLING TV) are on-going and may result, if not settled before the given time, in a given content and/or a channel not being (or being, as the case may be) available at a present or later arising time. The given content/channel may be specific to one or more programs (e.g., THE BACHELOR), a channel (e.g., ABC), a regional or local broadcasting station (e.g., KMGH—a distributor of ABC programming in Denver, Colorado), a given collection of channels (e.g., channels operates by Sinclair Broadcast Group Inc., of Cockeysville, Maryland, USA), or otherwise.

When such contract negotiations are not resolved before the given time or the availability of one or content and/or channels otherwise changes (e.g., from available to unavailable or unavailable to available), the access designation server 104 may be configured to automatically designate, at the given time, the one or more content/channels accordingly and generate an MLI which informs the DL 130 of the same.

For at least one implementation, an MLI may have an “active” status until cancelled or otherwise changed by a later arising MLI, the passage of time, or as otherwise specified or determined by the MLI itself or other inputs by a CAMS operator. The DL 130 may be configured to restrict access by the one or more user device(s) 142 affected by the MLI to one or more distribution nodes 136, content stored on the user device(s) 142, or take other actions which inhibit presentation of a given content or channel by given user device(s) 142, while the MLI is active.

As shown in FIG. 1, the DL 130 may include various DLEs including, for example and not by limitation, a content control server 132 and one or more distribution networks 134 that include one or more distribution nodes 136. A distribution node 136 may be any device, system, component, or the like configured to communicate content to a user device 142 on a content-by-content basis, on a channel basis, on a group of channels basis, or otherwise. Non-limiting examples of distribution nodes 136 include satellite feeds, cable system local nodes, content distribution network (CDN) components, web servers (e.g., an ESPN content server), and the like. The content control server 132 may be configured to instruct a user device 142 as to which distribution node(s) 136 a given content and/or one or more channels is or is not available at any given time or period.

As shown, the CAMS 100 elements may be communicatively coupled using one or more couplings 160.

### User Device 104

For at least one implementation, the CAMS 100 may include one or more user devices 142. A user device 142 may include one or more device components including, but not limited to, a processor, a data store, a user interface, a communications interface, a power supply, a security component, and other components. The one or more components may be provided with the device or elsewhere, e.g., a remote data store accessible to the device by one or more couplings may be used.

The user device 142 may be configured to execute one or more applications which facilitate the presentation of content to a user, in accordance with one or more MLIs.

### Access Designation Server 104

For at least one implementation, the CAMS 100 may include an access designation server 104. The Access Designation Server may be implemented as a server, with a non-limiting example of a server being shown in FIG. 2.

As shown in FIG. 2, a server 200 may include a processor 202 which executes non-transient computer instructions stored in a data store 204 for executing applications, instantiating one more computer engines 203, and performing other device related operations. The computer engines 203 instruct the server and/or other CAMS 100 components to perform various operations which facilitate (among other operations) processing, communication, storage and the like of MLIs between CAMS 100 components, such as between the ML 102 and the DL 130. For at least one implementation, computer engines 203 may also be utilized to facilitate communication of messages between components of the ML 102 and the CSL 120. Communication of data between a server 200 and another CAMS 100 component may utilize a communications interface 210 that respectively couples the given server with the other system component(s). The server 200 may further include one or more user interfaces 208, power supply 206, security component 212, and other commonly utilized components for one or more computers and/or computer servers. The server components may be communicatively coupled, e.g., by a bus 214 or otherwise. Any number of access designation servers 104 may be used for a given implementation of the present disclosure with one access designation server 104 being shown in FIG. 1 for purposes of clarity of this description.

### Programming Server 106

For at least one implementation, the CAMS 100 may include a programming server 106. The programming server 106 may be a server 200 and may include at least one or more of the components shown in FIG. 2.

One or more of the components and/or features and functions facilitated by an access designation server 104 and a programming server 106 may be logically and/or physically separate, combined, virtualized, distributed, or otherwise arranged for a given implementation of the present disclosure.

### ML Data Store 108

The ML data store 108 may be configured as a data store which stores one or more content availability listings, MILs, program guide listings, and the like. ML data store 108 may be accessible by one or more of the CAMS 100 components via the Cloud or other couplings.

### Access Engine 105

For at least one implementation, the access designation server 104 may be configured to execute computer instructions which instantiate an access engine 105. The access engine 105 directs one or more CAMS 100 operations which facilitate content availability management (such operations being herein a “CAMS operation”). For at least one implementation, the access engine 105 communicates with the program engine 107 to determine terms under which content and/or channels are (un)available to one or more user devices associated with a given content distribution system. For at least one implementation, the access engine 105 may be configured to associate regions with content/channel (un)availability terms and conditions, which may change on any basis and/or at any time.

### Program Engine 107

For at least one implementation, the programming server 106 may be configured to execute computer instructions which instantiate a program engine 107. The program engine 107 directs one or more CAMS 100 operations which facilitate content availability management (such operations being herein a “CAMS operation”). For at least one implementation, the program engine 107 communicates with content sources 122 to determine if, when and/or how content and/or channels are (un) available to users of a given content distribution system.

### Control Engine 133

For at least one implementation, the content control server 132 may be configured to execute computer instructions which instantiate a control engine 133. The control engine 133 receives MLI's from the access engine 105 and based thereon implements one or more content and/or channel takedowns and/or related content/channel restrictions across the distribution network 134 and with respect to one or more user devices 142. The control engine 133 may be configured to instruct user devices 142 to facilitate (un)availability of content/channels, identifications of such (un)availability one electronic programming guides (EPGs), via text messages, pop-up messages, or otherwise.

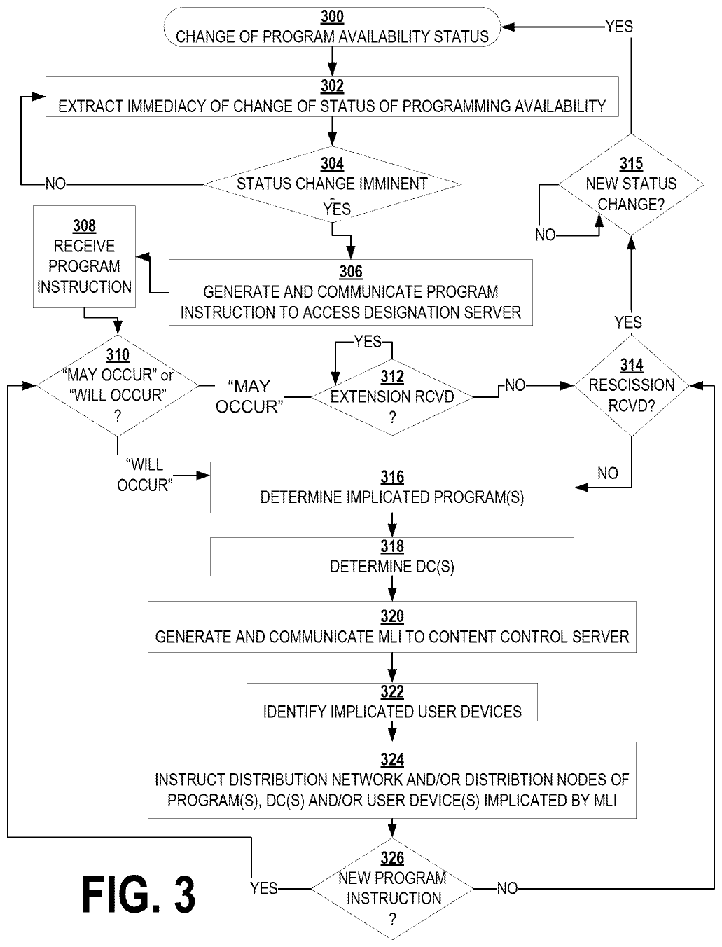

As shown in FIG. 3, a process for managing content availability in accordance with at least one implementation of the present disclosure includes one or more operations instructed by an access engine 105, a program engine 107, and/or a control engine 133 with respect to one more CAMS 100 elements.

As shown by Operation 300, the process may begin upon the program engine 107 receiving a program status change. The program status change may include a change in an (un)availability of a program, a program characteristic (e.g., whether the content is available in standard definition, high definition, 4K, or otherwise), a distribution network constraint (e.g., available for broadcast, streaming, download, or otherwise), a user device constraint (e.g., available for fixed location, mobile, or other types of user devices), and/or otherwise.

For at least one implementation, the program status change may be provided by one or more content sources 122 and with respect to any given program(s). For another implementation, the program status change may be generated upon user input, generated by an automated determination of program availability rights (e.g., a data listing identifying terms of past, current and/or future content access rights), based upon messages or other communications received from a content source, or otherwise.

As shown by Operation 302, the process may begin with the program engine 107 extracting, from a received program status change message, an immediacy in a change in status of programming availability with respect to one or more programs. The immediacy may indicate when potential, pending, actual, or other change in status of program availability is to occur.

As shown by Operation 304, the process may include the program engine 107 determining whether the identified change in programming availability is imminent. As used herein for at least one implementation, “imminent” means occurring within a following twenty-four hour (24 hour) period. For other implementations, “imminent” may mean within one or more weeks, days, hours, minutes, or otherwise. The time period utilized in determining when a status change is imminent may be predetermined, specified by the programming server 106, the access designation server 104, the content control server 132, or otherwise determined or specified. Whether a given time period is “imminent” may vary from time to time, by content source, CAMS 100 limitations, or otherwise. When the program status change is not determined to be imminent, the process may continue with Operation 302. When the program status change is determined to be imminent, the process may continue with Operation 306.

As shown by Operation 306, the process may include the program engine 107 generating and communicating a program instruction to the access designation server 104. The program instruction may designate one or more programs (e.g., content, content channels, content sources, and/or otherwise) that are implicated by the change in programming availability.

As shown by Operation 308, the process may include the access engine 105 receiving the program instruction.

As shown by Operation 310, the process may include the access engine 105 determining whether the program instruction designates a change in programming availability as “may occur” or “will occur”. When the designation of “may occur” is provided, the process may proceed with Operation 312. When the designation of “will occur” is provided, the process may proceed to Operation 316.

As shown by Operation 312, the process may include the access engine 105 determining, by the access engine 105, whether an extension of time for the “may occur” programming instruction has been received, within a given period of the last received programming instruction. If an extension is received, the process may include repeating Operation 312 during the extension period. If an extension is not received, the process may proceed to Operation 314.

As shown by Operation 314, the process may include determining, by the access engine 105, whether a rescission of the “may occur” programming instruction has been received. If “yes”, the process may proceed to Operation 315. If “no”, the process may change the status of the programming instruction from “may occur” to “will occur” and proceed with Operation 316.

As shown by Operation 315, the process may include the program engine 107 determining when a new status change of program availability has been received. When such a status change has been received (as indicated by “YES”), the process may continue with Operation 300, otherwise, the process may be repeated (as indicated by “NO”) until a new status change is received or another event or condition results in termination of the process.

As shown by Operation 316, the process may include the access engine 105 determining which program(s) are implicated by the programming instruction. The access designation server 104 may maintain, for example, in the ML data store 108, an association of content source(s), content, channels, and the like. A programming instruction may provide that content and/or channels (i.e., programs) provided by a given content source 122 are subject to a change in program availability (e.g., being unavailable or available) at a given time and/or for a given period.

As shown by Operation 318, the process may include the access engine 105 determining which DCs are implicated by the programming instruction. It is to be appreciated that a given user device 142 may be mobile and thus associated with a given DC at a first time while being associated with another DC at a second time. Accordingly, for at least one implementation, the programming instruction specifies DCs implicated by the change in program availability.

As shown per Operation 320, the process may include the access engine 105 generating and communicating an MLI to the content control server 132. For at least one implementation, the MLI identifies one or more DCs and/or user devices implicated by the change in program availability, as well as the content, channels and the like so implicated.

As shown per Operation 322, the process may include the control engine 133 identifying user devices implicated by the MLI. For at least one implementation, the control engine 133 may access a data store that includes identifications of current locations of one or more user devices 142 and, based thereon, identify those user devices 142 implicated by the DDC(s) identified in the MLI.

As shown per Operation 324, the process may include the control engine 133 instructing one or more element of the distribution network 134, including one or more distribution nodes 136, of programs, DCs, and/or user devices implicated by the MLI. Based upon such instruction, the distribution networks 134 and distribution nodes 136 may be configured to provide or not provide the one or more content and/or channels identified in the MLI to the designated (if not all) user devices 142, to user devices in the designated DCs, and/or as otherwise designated.

As shown per Operation 326, the process may include determining whether a new program instruction has been received within a given period. The given period may be predetermined, specified in the MLI, or otherwise specified. If “YES,” the process may return to Operation 310. If “NO”, the process may return to Operation 314.

By implementing the Operations of FIG. 3, a CAMS 100 may be configured to automatically configured CAMS 100 element such that programs are available or unavailable across the CAMS 100 at any given time and in response to any given program instruction provided by a content source or otherwise.

Although various implementations have been described above with a degree of particularity, or with reference to one or more individual implementations, those skilled in the art could make numerous alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A process comprising:
executing, by a first processor in a programming server, non-transient computer instructions which instantiate a program engine;
wherein the program engine instructs the programming server to perform first operations comprising:
receiving a program status change message from a content source;
wherein the program status change message identifies a program, of a plurality of programs provided by the content source to one or more user devices, subject to a change in program availability;
extracting from the program status change message an immediacy status for the change in program availability;
determining whether the immediacy status is imminent or not imminent;
generating a program instruction when the immediacy status is imminent; and
wherein the program instruction identifies the program subject to the change in program availability;
communicating the program instruction to an access designation server.

2. The process of claim 1, further comprising:
executing, by a second processor in the access designation server, non-transient computer instructions which instantiate an access engine;
wherein the access engine instructs the access designation server to perform second operations comprising:
receiving the program instruction from the programming server;
determining whether the program instruction designates the change in program availability “will occur” or “may occur”;
when the program instruction designates the change in program availability status “will occur” the second operations further comprising:
determining the program from the plurality of programs, subject to the change in program availability;
determining one or more Designated Criteria (DC(s)) implicated by the change in program availability;
generating a Management Layer Instruction (MLI); and
wherein the MLI identifies the one or more DC(s) implicated by the change in program availability;
communicating the MLI to a content control server.

3. The process of claim 2, further comprising:
executing, by a third processor in the content control server, non-transient computer instructions which instantiate a control engine;
wherein the control engine instructs the content control server to perform third operations comprising:
receiving the MLI from the access designation server;
identifying at least one user device, from the one or more user devices, implicated by the MLI; and
instructing at least one distribution node of a distribution network of at least one of the program, the DC(s) and the at least one user device implicated by the MLI.

4. The process of claim 3,
wherein upon being instructed of at least one of the program, the DC(s), and the at least one user device implicated by the MLI, the at least one distribution node is reconfigured in accordance with the program status change message.

5. The process of claim 4,
wherein the reconfiguring of the at least one distribution node results in the program being unavailable for providing to the at least one user device implicated by the MLI.

6. The process of claim 4,
wherein the reconfiguring of the at least one distribution node results in the program becoming available for providing to the at least one user device implicated by the MLI.

7. The process of claim 3,
wherein the content source is on a content source layer of a content availability management system (CAMS);
wherein the programming server is on a management layer of the CAMS and is coupled to the content source; and
wherein the content control server is on a distribution layer of the CAMS and is coupled to the programming server.

8. The process of claim 3,
wherein the access designation server is conceptually located on the management layer.

9. The process of claim 8,
wherein the at least one distribution node is on the distribution layer and is coupled to the content control server;
wherein the at least one user device is on a user layer of the CAMS, is coupled to the programming server, and is coupled to the at least one distribution node; and
wherein the at least one user device receives the program, when available, from the content source via the at least one distribution node.

10. The process of claim 3,
wherein the DC(s) identify at least one characteristic of the at least one user device.

11. The process of claim 10,
wherein the DC(s) identify a Designated Market Area (DMA).

12. A system comprising:
a content source;
a programming server;
an access designation server; and
a content control server;
wherein the programming server comprises:
a first processor;
a first communications interface coupling the programming server with the access control server and with the content source; and
a first data store, coupled to the first processor, storing first non-transient computer instructions which, when executed by the first processor, instantiate a program engine;
wherein the program engine instructs the programming server to perform first operations comprising:
receiving a program status change message from a content source;
wherein the program status change message identifies a program, of a plurality of programs provided by the content source to one or more user devices, subject to a change in program availability;
extracting from the program status change message an immediacy status for the change in program availability; and
determining whether the immediacy status is imminent or not imminent.

13. The system of claim 12,
wherein, when the immediacy status is imminent, the first operations further comprise:
generating a program instruction that identifies the program subject to the change in program availability; and
communicating the program instruction to an access designation server.

14. The system of claim 12,
wherein the access designation server comprises:
a second processor;
a second communications interface coupling the access designation server with the programming server and the content control server; and
a second data store, coupled to the second processor, storing second non-transient computer instructions which, when executed by the second processor, instantiates an access engine which instructs the access designation server to perform second operations comprising:
receiving a program instruction from the programming server; and
determining whether the program instruction designates the change in program availability “will occur.”

15. The system of claim 14,
wherein, when the program instruction designates the change in program availability status “will occur”, the second operations further comprising:
determining the program from the plurality of programs, subject to the change in program availability;
determining one or more Designated Criteria (DC(s)) implicated by the change in program availability;
generating a Management Layer Instruction (MLI); and
wherein the MLI identifies the one or more DC(s) implicated by the change in program availability;
communicating the MLI to a content control server.

16. The system of claim 15,
wherein the content control server comprises:
a third processor;
a third communications interface coupling the content control server with the access control server, and a distribution network;
wherein the distribution network includes at least one distribution node; and
a third data store, coupled to the third processor, storing third non-transient computer instructions which, when executed by the third processor, instantiate a control engine;
wherein the control engine instructs the content control server to perform third operations comprising:
receiving the MLI from the access designation server;
identifying at least one user device, from the one or more user devices, implicated by the MLI; and
instructing the at least one distribution node of the distribution network of the program, the DC(s), and the at least one user device implicated by the MLI.

17. The system of claim 15,
wherein the DC(s) identify at least one characteristic of the at least one user device implicated by the MLI.

18. The system of claim 15,
wherein the DC(s) identify a Designated Market Area (DMA).

19. A system comprising:
a management layer including a first server;
a content source layer including a content source;
a distribution layer including a content control sever and at least one distribution node; and
a user layer including at least one user device;
wherein the management layer is coupled to the content source layer and the distribution layer;
wherein the distribution layer is further coupled to the content source layer and the user layer;
wherein, the first server performs first operations comprising:
receiving a program status change message from a content source;
wherein the program status change message identifies a program, of a plurality of programs provided by the content source to one or more user devices, subject to a change in program availability;
extracting from the program status change message an immediacy status for the change in program availability; and
determining whether the immediacy status is imminent or not imminent;
when the immediacy status is imminent, generating a program instruction that identifies the program subject to the change in program availability;
determining whether the program instruction designates the change in program availability “will occur” or “may occur”;
when the program instruction designates the change in program availability status “will occur”, the first operations further comprising:
determining the program from the plurality of programs, subject to the change in program availability;
determining one or more Designated Criteria (DC(s)) implicated by the change in program availability;
generating a Management Layer Instruction (MLI); and
wherein the MLI identifies the one or more DC(s) implicated by the change in program availability;
communicating the MLI to a content control server.

20. The system of claim 19,
wherein the content control server performs content control operations comprising:
receiving the MLI from the first server;
identifying the at least one user device, from a one or more user devices, implicated by the MLI; and
instructing the at least one distribution node of the program, the DC(s), and the at least one user device implicated by the MLI.
